(19) United States
(12) Patent Application Publication
(10) Pub. No.: US 2026/0012514 A1
(43) Pub. Date: Jan. 8, 2026

(54) SERVICE-BASED IOT SYSTEM EMPLOYING HASHTAGS

(71) Applicants: Seoul National University R&DB Foundation, Seoul (KR); MySmaX Co., Ltd., Seoul (KR)

(72) Inventors: Soonhoi HA, Seoul (KR); Euiseok KIM, Seoul (KR)

(73) Assignees: Seoul National University R&DB Foundation, Seoul (KR); MySmaX Co., Ltd., Seoul (KR)

(21) Appl. No.: 19/242,824

(22) Filed: Jun. 18, 2025

(30) Foreign Application Priority Data
Jul. 4, 2024 (KR) 10-2024-0088334

(51) Int. Cl. H04L 67/51

(52) U.S. Cl. CPC H04L 67/51

(57) ABSTRACT

Provided is a service-based Internet of Things (IoT) system employing hashtags. The service-based IoT system includes a plurality of IoT devices each of which registers a list of providable services with IoT edge devices in the same network and receives a service request from an IoT edge device to process the service request, and a plurality of IoT edge devices each of which includes middleware configured to register and manage the IoT devices in the same network and services provided by the IoT devices, and a hashtag assignor configured to assign hashtags input by a user to the registered IoT devices or the registered services. The middleware selects an IoT device that will process a service on the basis of a hashtag included in the service request.

### CROSS-REFERENCE TO RELATED APPLICATION(S)

This application claims priority from Korean Patent Application No. 10-2024-0088334, filed on Jul. 4, 2024, in the Korean Intellectual Property Office, the disclosure of which is incorporated herein by reference in its entirety.

### BACKGROUND

### 1. Field

The following description relates to a service-based Internet of Things (IoT) platform, and more particularly, to a technology for requesting a service using a hashtag assigned to the service.

### 2. Description of Related Art

The Internet of Things (IoT) is gradually becoming pervasive in our daily lives, and hundreds of IoT platforms are under development to keep up with this IoT growth. IoT platforms are software frameworks that enable the management and connection of various smart devices and applications over the Internet, serving as a bridge between layers of an IoT system which range from the device layer to the application layer.

IoT platforms may be broadly categorized into cloud-based and edge-based types on the basis of the location of middleware. Cloud-based platforms deploy platform-as-a-service (PaaS) middleware in the cloud and connect IoT devices over an Internet network. Cloud-based platforms are more popular because of their ease of implementation, low cost, and extensibility. On the other hand, edge-based platforms have several advantages over cloud-based platforms by providing the functions of cloud computing to edge devices. Edge-based IoT platforms do not need to transmit data to the cloud and thus show low latency and improved responsiveness and additionally have security benefits. Also, edge-based IoT platforms can continuously operate even when network conditions are poor.

In addition, service-oriented IoT architectures are being researched. Most early IoT platforms are device-oriented, which means that a user defines an IoT application by controlling an IoT device personally. On the other hand, service-oriented platforms abstract IoT devices into a set of services provided by the IoT devices, and IoT applications are defined on the basis of a service requested by a user. According to service-oriented IoT, a device is abstracted into a set of services provided by the device, and thus a user requests a service instead of accessing the device to run a new IoT application. However, disallowing multiple devices to share the same service name is not considered service-oriented in a strict sense.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description relates to providing a service-based Internet of Things (IoT) system for selecting an IoT device on the basis of a service without a user personally assigning the IoT device when there are multiple IoT devices that may perform a service requested by the user in the IoT system.

The following description also relates to providing a service-based IoT system for providing a method of delivering a command that is intuitively wanted by a user to the IoT system without a complex process of specifying a service.

Technical objects to be achieved in the present invention are not limited to those described above, and other technical objects that have not been described will be clearly understood by those of ordinary skill in the art from the following description.

In one general aspect, a service-based IoT system employing hashtags includes one or more IoT devices and one or more IoT edge devices.

Each of the IoT devices registers a list of providable services with the IoT edge devices in the same network and receives a service request from an IoT edge device to process the service request.

Each of the IoT edge devices includes middleware configured to register and manage the IoT devices in the same network and services provided by the IoT devices, and a hashtag assignor configured to assign hashtags input by a user to the registered IoT devices or the registered services.

The middleware selects an IoT device that will process a service on the basis of a hashtag included in the service request.

The hashtag assignor may assign a hashtag that is input by the user or set for the IoT edge device to the middleware, and the middleware may assign the hashtag assigned thereto to the registered IoT devices or services.

When the IoT devices are registered with the IoT edge devices, one or more basic hashtags which have been set during manufacturing of the IoT devices may be additionally registered.

The service request may include a string in which at least one hashtag and a service name are combined.

When a plurality of IoT devices are found using the hashtag included in the service request, the middleware may select all IoT devices that provide a service with the service name combined with the hashtag among the found IoT devices as IoT devices that will process the service.

The one or more IoT edge devices may form a tree-shaped hierarchical structure, an IoT edge device having a higher layer may forward a list of published services to an IoT edge device in the higher layer, and the IoT edge device in the higher layer may have the right to access the services published by the IoT edge device in a lower layer. Here, the service list may include service names and hashtags assigned to the services.

The hashtag assignor may assign a hierarchical level of the IoT edge device or identification information assigned to a layer of the IoT edge device to the middleware as a hashtag.

The IoT edge device in the higher layer may generate a composite service by combining a service registered with the IoT edge device with a service published by the IoT edge device in the lower layer or combining services published by the IoT device in the lower layer, and a request for each of the services constituting the composite service may include a string in which at least one hashtag and a service name are combined.

The IoT edge device may dynamically manage an execution state of a service provided by the IoT edge device and report the execution state in response to a service execution state report request received from the IoT edge device in the higher layer.

The IoT edge device in the higher layer that requests execution of the service published by the IoT edge device in the lower layer that is included in the composite service may check availability of the service from the IoT edge device in the lower layer before requesting the execution of the service.

### BRIEF DESCRIPTION OF THE DRAWINGS

FIG. 1 is a diagram showing an example of using hashtags in an Internet of Things (IoT) system including one IoT edge device according to the present invention.

FIG. 2 is a diagram illustrating various examples of assigning hashtags.

FIG. 3 is a conceptual diagram illustrating an example of a composite service.

FIG. 4 is a conceptual diagram of an IoT system having IoT edge devices in a hierarchical structure according to the present invention.

### DETAILED DESCRIPTION

The above-described and additional aspects will be specified through exemplary embodiments described with reference to the accompanying drawings. It will be understood that components of each of the embodiments may be variously combined within the embodiment unless otherwise stated or contradicted. Each block of block diagrams may represent a physical part in some cases, or may be a logical representation of some functions of one physical part or a function of a plurality of physical parts in other cases. In some cases, the entity of a block or a part of the block may be a set of program instructions. All or some of these blocks may be implemented as hardware, software, or a combination thereof.

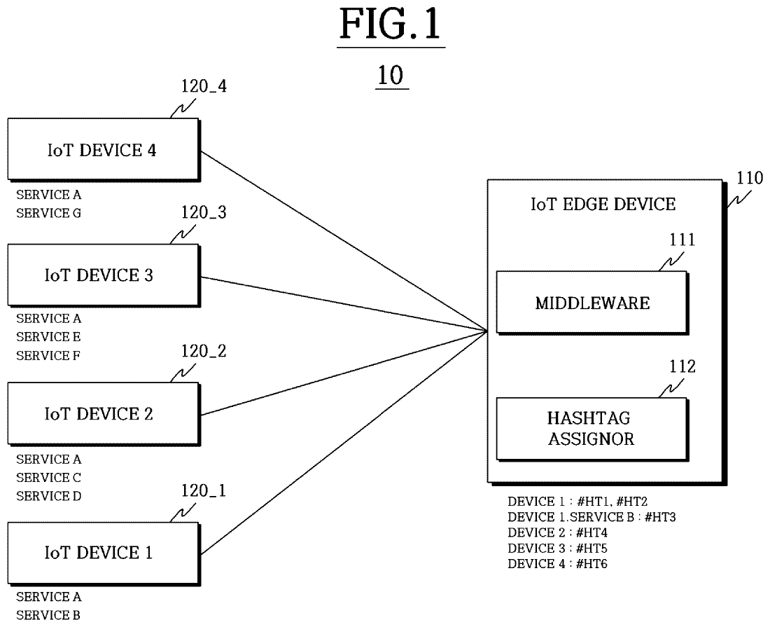

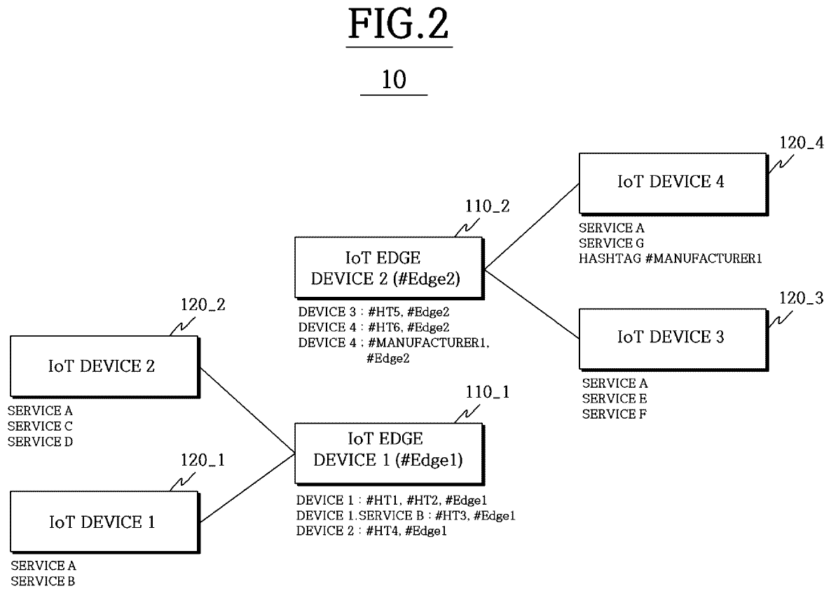

FIG. 1 is a diagram showing an example of using hashtags in an Internet of Things (IoT) system including one IoT edge device according to the present invention, and FIG. 2 is a diagram illustrating various examples of assigning hashtags. A service-based IoT system 10 employing hashtags according to an aspect of the present invention includes one or more IoT devices 120 and at least one IoT edge device 110.

The IoT system 10 of the present invention is an edge-based platform and a service-based IoT system. The IoT devices 120 abstract functions provided by themselves into services and register the services with the IoT edge device 110.

The IoT devices 120 are hardware devices that are controlled or exchange data via a network such as sensors, home appliances, and other machines. The IoT devices 120 of the present invention generate service lists from providable services and register the service lists with the IoT edge device 110 in the same network. The service lists that are used for registration by the IoT devices 120 are lists of names of the abstracted services that are providable by the IoT devices 120.

The IoT devices 120 receive a service execution request from the IoT edge device 110 and process the service, or the IoT edge device 110 receives a control command obtained by converting a corresponding service to execute the service.

The IoT edge device 110 may be a hub device with computing capability. The IoT edge device 110 includes middleware 111. The middleware 111 relays all communication of IoT devices that are geographically close to each other and thus use the same network, thereby implementing a smart office, a smart home, or the like.

The IoT edge device 110 includes the middleware 111 and a hashtag assignor 112.

The middleware 111 searches for the IoT devices 120 in the same network and registers and manages services provided by the found IoT devices 120.

The IoT edge device 110 may additionally provide a user interface for a user to assign hashtags to IoT devices 120 or services that are registered with the IoT edge devices 110 in accordance with his or her intention. The user interface provided by the IoT edge device 110 may be an interface that is interoperable with an application run on a mobile terminal, such as a smartphone or the like, or a computing device, such as a computer or the like, used by the user or an interface that is interoperable with the computing device of the user on the basis of the web. When the IoT edge device 110 interoperates with the computing device of the user on the basis of the web, the IoT edge device 110 additionally includes a web server.

The hashtag assignor 112 assigns hashtags input by the user through the user interface to the registered IoT devices 120 or the registered services. When hashtags are assigned to the IoT devices 120, the hashtags are used for identifying the devices, and the same hashtag may be assigned to a plurality of IoT devices. When hashtags are assigned to the registered services, the hashtags are used for identifying services provided by a specific IoT device, and the same hashtag may be assigned to a plurality of services. In other words, the present invention does not have any limitation on how the user assigns hashtags, and thus the same hashtag may be assigned to different services.

In the example shown in FIG. 1, the hashtag assignor 112 assigns hashtags #HT1 and #HT2 to IoT device 1 (120_1), assigns hashtag #HT4 to IoT device 2 (120_2), assigns hashtag #HT5 to IoT device 3 (120_3), and assigns hashtag #HT6 to IoT device 4 (120_4). Also, the hashtag assignor 112 assigns hashtag #HT3 to service B of IoT device 1 (120_1).

In the example shown in FIG. 2, hashtags #HT1, #HT2, #HT4, #HT5, and #HT6 are assigned to the IoT devices 120_1, 120_2, 120_3, and 120_4 in accordance with a user input, hashtag #HT3 is assigned to a specific service of the specific IoT device 120_1, hashtags #Edge1 and #Edge2 are assigned to the IoT edge devices 110_1 and 110_2 in accordance with a user input or a previous setting, and hashtag #manufacturer1 is assigned to the IoT device 120_4 during manufacturing of the IoT device 120-4.

The middleware 111 selects an IoT device 120 that will process a service on the basis of a hashtag included in a service request. When the hashtag has been assigned to an IoT device 120, the middleware 111 may perform a search using the hashtag to select a plurality of IoT devices. When the hashtag has been assigned to a service, the middleware 111 may select a specific service of a specific IoT device or a specific service of one or more IoT devices 120.

The IoT edge device 110 may additionally provide a user interface for the user to request a service that he or she wants. The user interface provided by the IoT edge device 110 may be an interface that is interoperable with an application run on a mobile terminal, such as a smartphone or the like, or a computing device, such as a computer or the like, used by the user or an interface that is interoperable with the computing device of the user on the basis of the web.

The user may input a service request, but an application executed on the IoT edge device 110 may also request a service.

The service request may include a string in which at least one hashtag and a service name are combined.

The hashtag that is used in accordance with the intention of the user who requests the service using the hashtag reduces a range of IoT devices 120 that perform the service. Here, the IoT edge device 110 may execute the corresponding service of the IoT device 120 that provides the service corresponding to the service name among all IoT devices that are found using the hashtag, in accordance with a policy or an implementation method. When multiple IoT devices 120 provide the service, the IoT edge device 110 may simultaneously request execution of the service or select one of the IoT devices 120 and cause the selected IoT device 120 to execute the service.

According to the present invention, a hashtag may be assigned to the middleware 111 run on the IoT edge device 110. Since the middleware 111 implements a smart office, a smart home, or the like using IoT devices that are geographically close to each other and thus use the same network, it may be necessary to assign the same hashtag to IoT devices registered with the middleware 111 to distinguish the smart office, the smart home, or the like from other smart offices, smart homes, or the like. In addition to this purpose, a hashtag may be assigned to the middleware 111 and used on the basis of the user's intention.

According to an aspect of the present invention, the hashtag assignor 112 may assign a hashtag input by the user or a hashtag preset for the IoT edge device 110 to the middleware 111.

The middleware 111 may additionally assign the hashtag assigned thereto to all the registered IoT devices 120 or services.

The user may assign hashtags to the IoT devices 120 registered with the IoT edge device 110, or hashtags may be added to the IoT devices 120 in advance. As an example, general information corresponding to the IoT devices 120, such as manufacturer information, device categories, and the like, may be set for the IoT devices 120 during manufacturing of the IoT devices 120. According to the present invention, general information may be defined as basic hashtags and set for devices by default irrespective of whether a user uses the basic hashtags.

According to an aspect of the present invention, when the IoT devices 120 are registered with the IoT edge device 110, one or more basic hashtags which have been set during manufacturing of the IoT devices 120 may be additionally registered. In other words, when the IoT devices 120 include basic hashtags at the time of being registered with the middleware 111, the basic hashtags are also forwarded to register the IoT devices 120.

According to the present invention, a hashtag included in a service request may be used to search for an IoT device 120 or a service provided by an IoT device 120. Here, the middleware 111 searches for an IoT device 120 using the hashtag included in the hashtag. When a plurality of IoT devices are found as a result, the middleware 111 may select all IoT devices that provide a service with a service name combined with the hashtag among the found IoT devices as IoT devices that will process the service. Here, the middleware 111 may execute the corresponding service of the IoT devices 120 that provide the service corresponding to the service name among all IoT devices that are found using the hashtag, in accordance with a policy or an implementation method. When multiple IoT devices 120 provide the service, the IoT edge device 110 may simultaneously request execution of the service or select one of the IoT devices 120 and cause the selected IoT device 120 to execute the service.

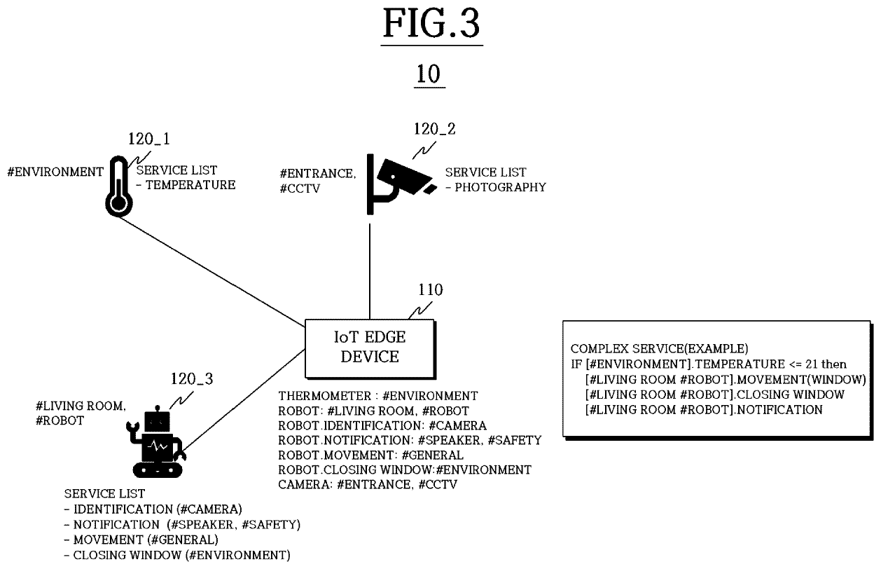

FIG. 3 is a conceptual diagram illustrating an example of a composite service. The middleware 111 of the IoT edge device 110 may generate a new composite service by combining services registered therewith. The composite service is an application program written in a scripting language or a programming language. When the composite service is written in a scripting language, the IoT edge device 110 additionally includes a user interface for defining the composite service in the form of a script. There are no limitations on the format of a scripting language for defining the composite service, but it preferably supports control statements based on general scripting languages.

The IoT edge device 110 generating the composite service may also assign a hashtag to the composite service.

In the example of FIG. 3, “#environment” is assigned to an IoT thermometer 120_1, “#entrance” and “#CCTV” are assigned to a closed-circuit television (CCTV) 120_2, and “#living room” and “#robot” are assigned to a robot 120_3. Hashtags are also assigned to services provided by the robot 120_3. According to the composite service illustrated in FIG. 3 that is generated on the basis of the IoT devices 120_1, 120_2, and 120_3 and the hashtags, when the indoor temperature is 21 degrees or lower, the robot moves to the windows, closes the windows, and outputs a notifying voice.

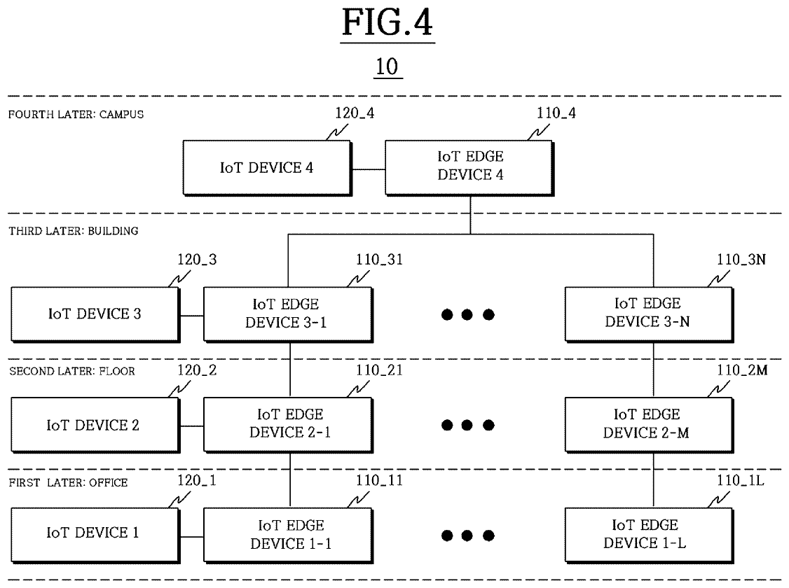

FIG. 4 is a conceptual diagram of an IoT system having IoT edge devices in a hierarchical structure according to the present invention. According to another aspect of the present invention, a plurality of IoT edge devices form a tree-shaped hierarchical structure. An IoT system 10 of the present invention easily addresses the problem of system extensibility by employing a hierarchical structure of IoT edge devices. As shown in the example of FIG. 4, IoT edge devices form a tree-shaped hierarchical structure.

An IoT edge device (e.g., 110_11) having higher layers forwards a list of published services to IoT edge devices (e.g., 110_21, 110_31, and 110_4) in the higher layers, and the IoT edge devices (e.g., 110_21, 110_31, and 110_4) in the higher layers have the right to access the services published by the IoT edge device (e.g., 110_11) in a lower layer. Here, the service list may include service names and hashtags assigned to the services.

IoT edge devices 110 abstract functions provided by IoT devices 120 into services and provide the services. Here, the services may be abstracted in the form of application programs that are written in a scripting language or a programming language and implemented. A user or the like may request a service using a hashtag or a string composed of at least one hashtag and a service name. An IoT edge device 110 executes the service corresponding to the hashtag or the string composed of the at least one hashtag and the service name and gives an IoT device 120 a control command related to execution of the service to control the IoT device 120.

Middleware 111 maps the IoT devices 120 to the services provided by the IoT devices 120 and manages them. For example, the middleware 111 may map device identifiers (e.g., device identifications (IDs)) to service identifiers (e.g., service names) and manage them.

In addition, the middleware 111 sets whether to publish registered services. The IoT edge devices 110 provide a user interface for setting whether to publish a service such that the user or a manager may set a service public using the interface. Here, there are no limitations on the way the user interface provided by the IoT edge devices 110 is implemented.

According to the present invention, a service published by middleware 111 in a lower layer is executable by middleware 111 in higher layers on a path from the corresponding layer to the highest layer. The middleware 111 in the higher layers may execute the service published by the middleware 111 in the lower layer but is prevented from accessing data required for executing the service.

Middleware 111 determines whether there is a higher layer thereof, and when it is determined that there is a higher layer, forwards a list of services which are set public to middleware 111 in the higher layer. In other words, an IoT edge device 110 having a higher layer forwards a list of published services to an IoT edge device 110 in the higher layer. The middleware 111 in the higher layer receiving the list of published services from the middleware 111 in the lower layer may register and manage the services received from the lower layer separately from services registered therewith.

In addition, when there is a service request from another IoT edge device 110, middleware 111 determines whether the other IoT edge device 110 which has requested the corresponding service has an access right, that is, determines whether to provide the service depending on the access right. Here, IoT edge devices 120 in higher layers on a path from a lower layer to the highest layer have the right to access services published by an IoT edge device 110 in the lower layer.

The example of FIG. 4 has a hierarchical structure in which IoT edge devices are classified into four layers. The first layer is a layer of one office, the second layer is a layer of one floor, the third layer is a layer of one building, and the fourth layer is a layer of a campus including multiple buildings. A service published by IoT edge device 1-1 (110_11) is accessible to IoT edge device 2-1 (110_21), IoT edge device 3-1 (110_31), and IoT edge device 4 (110_4) in higher layers, but is inaccessible to IoT edge device 1-L (110_1L), IoT edge device 2-M (110_2M), and IoT edge device 3-N (110_3N).

Since the middleware 111 has a hierarchical structure, information related to layers (e.g., hierarchical levels) may be added as hashtags and utilized. Therefore, hashtag assignors 112 may assign the middleware 111 identification information assigned to the hierarchical levels or the layers of the IoT edge devices 110 as hashtags. As an example, when each building is in the third layer, each floor is in the second layer, and each office is in the first layer, “#3^{rd}floor” may be assigned to the middleware as a layer-related hashtag.

According to an aspect of the present invention, middleware 111 belonging to a lower layer of middleware 111 that sets a layer-related hashtag may additionally assign the layer-related hashtag to all registered IoT devices 120 or services. In the foregoing example, middleware 111 of an IoT edge device 110 for office 301 in the first layer may additionally assign “#3^{rd}floor” to all registered IoT devices 120 or services.

According to another aspect of the present invention, an IoT edge device 110 in a higher layer generates a composite service by combining a service registered with the IoT edge device 110 and a service published by an IoT edge device 110 in a lower layer or combining services published by an IoT edge device 110 in a lower layer. A request for each of the services constituting the composite service includes a string in which at least one hashtag and a service name are combined.

Here, the composite service is a new service that is generated using, as shared resources, IoT devices 120 registered with the IoT edge device 110 in the lower layer and published. The composite service is an application program written in a scripting language or a programming language.

The IoT edge device 110 generating the composite service may also assign a hashtag to the composite service.

Each individual service included in the composite service may be a service of the IoT device 120 connected to an IoT edge device 110 in another place, that is, a service registered with the IoT edge device 110 in the lower layer. Here, IoT devices 120 may be dynamically removed or become unavailable for service due to failure or the like. Therefore, when the composite service is executed, the services included in the composite service may fail to run.

When one service constituting the composite service fails to run, the IoT edge device 110 which processes the composite service may stop execution of the composite service and notify a user who has requested the composite service of the failure in processing the composite service.

In an IoT edge system in which a hierarchical structure is formed, a plurality of identical IoT devices 120 may be registered with different IoT edge devices 110 or the same IoT edge device 110 and used.

When a service constituting the composite service fails to run and the same service is provided by another IoT edge device 110, the IoT edge device 110 which processes the requested composite service may request the other IoT edge device 110 which provides the same service to execute the service which has failed to run. In other words, when a plurality of IoT devices 120 provide a specific service in the same way in the IoT system, it is possible to request another IoT edge device 110 which provides the service to execute the service without stopping execution of the composite service irrespective of a failure in executing the service.

Here, the other IoT edge device is required to publish the service, and the IoT edge device 110 which generates the composite service is required to be in a higher layer than the other IoT edge device for an access right. In other words, when IoT edge devices providing the same service are in lower layers than an IoT edge device in a higher layer generating a composite service and each of the IoT edge devices in the lower layers sets the service public, the service is forwarded to the IoT edge device in the higher layer generating the composite service.

Even when a specific service fails to run, middleware 111 which executes the composite service does not stop the composite service and checks whether there is another IoT edge device providing the same service mapped by the middleware 111. When there is another IoT edge device, the middleware 111 requests the same service from the other IoT edge device. According to an aspect of the present invention, when middleware 111 of an IoT edge device generating a composite service recognizes that one service constituting the composite service fails to run, (e.g., receives a notification of the failure from the middleware 111 of the IoT edge device), the middleware 111 may check whether there is another IoT edge device providing the same service mapped by the middleware 111 without forwarding the corresponding result to a user who has requested the service. When there is another IoT edge device, the middleware 111 may request the same service from the other IoT edge device.

When all other IoT edge devices providing the same service fail to execute the service, execution of the composite service is stopped as described above, and the user who has requested the service is notified of the failure in processing the composite service.

Since a plurality of identical IoT devices 120 may be registered with different IoT edge devices or the same IoT edge device and used as described above, this may be processed in a distributed manner according to the present invention.

According to another aspect of the present invention, when a service of a lower layer constituting a composite service is provided in the same way by a plurality of IoT edge devices, an IoT edge device 110 processing the composite service may request processing of the service such that the service constituting the composite service may be executed by the plurality of IoT edge devices in a distributed manner.

When a specific service constituting a composite service is processed by middleware 111 of an IoT edge device 110 executing the composite service and a plurality of mapped IoT edge devices provide the service in the same way, the plurality of IoT edge devices 110 may be requested to process the service in a distributed manner.

Here, even when the specific service of which distributed processing is requested fails to run, if there is another IoT edge device providing the same service mapped by the middleware 111, the middleware 111 executing the composite service can request the same service from the other IoT edge device without stopping the composite service.

According to another aspect of the present invention, each IoT edge device 110 dynamically manages an execution state of a service provided by itself. Middleware 111 of each IoT edge device 110 can monitor a state of a registered IoT device 120 and execution states of services provided by the IoT device 120 and dynamically manage the states.

Middleware 111 of each IoT edge device 110 manages a state of the IoT edge device 110 such that an IoT device 120 may be dynamically added or removed. When an IoT device 120 is removed, the middleware 111 may also remove services provided by the IoT device 120.

Middleware 111 may generate and manage a service state table for managing states of services provided by IoT devices 120 registered with a corresponding IoT edge device 110. The middleware 111 may manage service states as running and waiting to run. However, service states are not limited thereto, and other states may be added as necessary.

When execution of a service registered with the middleware 111 is requested, the middleware 111 checks an execution state of the service in the service state table. When the execution state of the service is waiting to run, the middleware 111 forwards the service execution request to a mapped IoT device 120 and changes the execution state of the service to running in the service state table. Subsequently, when the IoT device 120 executing the service notifies the middleware 120 that the execution has been completed, the middleware 111 changes the execution state of the service to waiting to run in the service state table.

Middleware 111 of an IoT edge device 110 in a higher layer may transmit a service execution state report request to identify an execution state of a service provided by the IoT edge device 110 in a lower layer.

When the service execution state report request is received from the IoT edge device 110 in the higher layer, middleware 111 of the IoT edge device 110 searches the service state table for the corresponding service and then reports the execution state in response to the request.

In the IoT system 10 of the present invention, middleware 111 of an IoT edge device 110 in a higher layer can request execution of a service published by an IoT edge device 110 in a lower layer. Whether the service is currently executable is managed by an IoT edge device 110 with which the service has been registered using a service state table. Even when the service is published, the IoT edge device 110 having an access right in the higher layer rather than the IoT edge device 110 with which the service has been registered does not directly manage a state of the service. Therefore, the IoT edge device 110 in the higher layer requests the service without being aware of whether the published service in the lower layer is executable, which leads to an unnecessary request when the service is inexecutable.

An IoT edge device 110 in a higher layer which requests execution of a service included in a composite service that is published by an IoT edge device in a lower layer may check availability of the service from the IoT edge device in the lower layer before requesting execution of the service. Here, middleware 111 of the IoT edge device in the higher layer may transmit a service execution state report request to middleware 111 of the IoT edge device in the lower layer and receive the result to check the availability of the service.

As described above, according to an aspect of the present invention, each IoT edge device 110 can dynamically manage execution states of services provided by itself. Middleware 111 of each IoT edge device 110 can monitor a state of a registered IoT device 120 and execution states of services provided by the IoT device 120 and dynamically manage the states.

An IoT edge device 110 executing a composite service can check availability of all services constituting the composite service and then start executing the composite service.

Middleware 111 of the IoT edge device 110 executing the composite service can check availability of all services constituting the composite service by requesting service execution state reports from IoT edge devices 110 with which IoT devices 120 mapped to the service have been registered, and then, when it is determined that all the services are available, can execute the composite service.

According to the present invention, when there are several IoT devices that may perform a service demanded by a user, it is possible to select an IoT device on the basis of the service without assigning the IoT device personally.

In addition, according to the present invention, it is possible to deliver a command that is intuitively wanted by a user to a service-based IoT system without a complex process of specifying a service.

Various exemplary embodiments disclosed in the present specification and the drawings merely present specific examples of the present invention to aid in understanding and are not intended to limit the scope of various embodiments of the present invention.

Therefore, the scope of various embodiments of the present invention should be construed to encompass all altered or modified forms derived from the technical spirit of various embodiments of the present invention in addition to the exemplary embodiments described herein.

What is claimed is:

1. A service-based Internet of Things (IoT) system employing hashtags, the IoT system comprising:
one or more IoT devices each of which is configured to register a list of providable services with IoT edge devices in the same network and receive a service request from an IoT edge device to process the service request; and
one or more IoT edge devices each of which includes middleware configured to register and manage the IoT devices in the same network and services provided by the IoT devices, and a hashtag assignor configured to assign hashtags input by a user to the registered IoT devices or the registered services,
wherein the middleware selects an IoT device that will process a service on the basis of a hashtag included in the service request.

2. The IoT system of claim 1, wherein the hashtag assignor assigns the middleware a hashtag that is input by the user or set for the IoT edge device, and
the middleware assigns the hashtag assigned thereto to the registered IoT devices or services.

3. The IoT system of claim 1, wherein, when the IoT devices are registered with the IoT edge devices, one or more basic hashtags which have been set during manufacturing of the IoT devices are additionally registered.

4. The IoT system of claim 1, wherein the service request includes a string in which at least one hashtag and a service name are combined.

5. The IoT system of claim 4, wherein, when a plurality of IoT devices are found using the hashtag included in the service request, the middleware selects all IoT devices that provide a service with the service name combined with the hashtag among the found IoT devices as IoT devices that will process the service.

6. The IoT system of claim 4, wherein the middleware generates a composite service by combining the registered services, and
a request for each of the services constituting the composite service includes a string in which at least one hashtag and a service name are combined.

7. The IoT system of claim 1, wherein the one or more IoT edge devices form a tree-shaped hierarchical structure,
an IoT edge device having a higher layer forwards a list of published services to an IoT edge device in the higher layer,
the IoT edge device in the higher layer has a right to access the services published by the IoT edge device in a lower layer, and
the service list includes service names and hashtags assigned to the services.

8. The IoT system of claim 7, wherein the hashtag assignor assigns a hierarchical level of the IoT edge device or identification information assigned to a layer of the IoT edge device to the middleware as a hashtag.

9. The IoT system of claim 7, wherein the IoT edge device in the higher layer generates a composite service by combining a service registered with the IoT edge device with a service published by the IoT edge device in the lower layer or combining services published by the IoT device in the lower layer, and
a request for each of the services constituting the composite service includes a string in which at least one hashtag and a service name are combined.

10. The IoT system of claim 9, wherein the IoT edge device dynamically manages an execution state of a service provided by the IoT edge device and reports the execution state in response to a service execution state report request received from the IoT edge device in the higher layer, and
the IoT edge device in the higher layer that requests execution of the service published by the IoT edge device in the lower layer that is included in the composite service checks availability of the service from the IoT edge device in the lower layer before requesting the execution of the service.
